(19) United States
(12) Patent Application Publication
(10) Pub. No.: US 2026/0175734 A1
(43) Pub. Date: Jun. 25, 2026

(54) Dynamic Display of Estimated Electric Vehicle Charge Times Based on Predicted Battery Preconditioning and Absent Destination Route Input

(71) Applicant: Nissan North America, Inc., Franklin, TN (US)

(72) Inventors: Corey Heath, Scottsdale, AZ (US); Stefan Witwicki, San Carlos, CA (US)

(21) Appl. No.: 18/988,058

(22) Filed: Dec. 19, 2024

(51) Int. Cl. B60L 53/68

(52) U.S. Cl. CPC B60L 53/68; B60L 2240/72; B60L 2260/52; B60L 2260/54

(57) ABSTRACT

Dynamic display of estimated electric vehicle charge times based on predicted battery preconditioning and absent destination route input is described. A method includes identifying one or more charger station locations based on a location of the EV vehicle and a defined distance, determining one or more routes for the one or more charger station locations absent a destination input, determining, for each of the one or more routes, values for a predicted battery state based on vehicle data, determining, for each of the one or more routes, an estimated charge time based on the predicted battery state, an ambient temperature, and charger station information, and providing the one or more charger station locations, the one or more routes, and associated estimated charging times for display to the user.

### TECHNICAL FIELD

This disclosure relates generally to electric vehicles, and more particularly to dynamically displaying electric vehicle charge stations and charge times.

### BACKGROUND

The automobile industry has been developing electric vehicles and hybrid electric-internal combustion vehicles (together, referred to as “electric vehicles” or “EVs”) in part to reduce emissions of carbon dioxide, thereby reducing air pollution and global warming. A common complaint amongst electric vehicle drivers is range anxiety. Potential buyers are apprehensive about when and where to charge their electric vehicle. Consequently, access to chargers can be a barrier to electric vehicle ownership and use.

### SUMMARY

A first aspect of the disclosed implementations is a method which includes identifying one or more charger station locations based on a location of the EV vehicle and a defined distance, determining one or more routes for the one or more charger station locations absent a destination input, determining, for each of the one or more routes, values for a predicted battery state based on vehicle data, determining, for each of the one or more routes, an estimated charge time based on the predicted battery state, an ambient temperature, and charger station information, and providing the one or more charger station locations, the one or more routes, and associated estimated charging times for display to the user.

A second aspect of the disclosed implementations is an electric vehicle (EV) which includes a processor. The processor configured to identify one or more charger station locations based on a location of the EV vehicle and a defined distance, determine one or more routes for the one or more charger station locations absent a destination input, determine, for each of the one or more routes, values for a predicted battery state based on vehicle data, determine, for each of the one or more routes, an estimated charge time based on the predicted battery state, an ambient temperature, and charger station information, and provide the one or more charger station locations, the one or more routes, and associated estimated charging times for display to the user.

A third aspect of the disclosed implementations is a non-transitory computer readable medium storing instructions operable to cause a processor to perform operations with respect to an electric vehicle (EV). The operations including identifying one or more charger station locations based on a location of the EV vehicle and a defined distance, determining one or more routes for the one or more charger station locations absent a destination input, determining, for each of the one or more routes, values for a predicted battery state based on vehicle data, determining, for each of the one or more routes, an estimated charge time based on the predicted battery state, an ambient temperature, and charger station information, and providing the one or more charger station locations, the one or more routes, and associated estimated charging times for display to the user.

Variations in these and other aspects, features, elements, implementations, and embodiments of the methods, apparatus, procedures, and algorithms disclosed herein are described in further detail hereafter.

### BRIEF DESCRIPTION OF THE DRAWINGS

The various aspects of the methods and apparatuses disclosed herein will become more apparent by referring to the examples provided in the following description and drawings in which like reference numbers refer to like elements.

FIG. 1 is a diagram of an example of a vehicle in which the aspects, features, and elements disclosed herein may be implemented.

FIG. 2 is a diagram of an example of a portion of a vehicle transportation and communication system in which the aspects, features, and elements disclosed herein may be implemented.

FIG. 3 illustrates a block diagram of a system for dynamic display of charger station locations, routes, and estimated charging times based on predicted battery state without the user of the vehicle inputting a destination.

FIG. 4 illustrates a display with a map for dynamic display of charger station locations, routes, and estimated charging times based on predicted battery state without the user of the vehicle inputting a destination.

FIG. 5 illustrates a block diagram of a system for dynamic display of charger station locations, routes, and estimated charging times based on predicted battery state without the user of the vehicle inputting a destination.

FIG. 6 illustrates a block diagram of a system for dynamic display of charger station locations, routes, and estimated charging times based on predicted battery state without the user of the vehicle inputting a destination.

FIG. 7 is a flowchart of a technique for implementing dynamic display of charger station locations, routes, and estimated charging times based on predicted battery state without the user of the vehicle inputting a destination.

### DETAILED DESCRIPTION

Electric vehicles can be charged at EV charging stations or chargers. There are systems and applications which display the location of EV charging stations. One such application shows the location of publicly available EV charging stations and the costs for charging at the EV charging stations. Another application shows the approximate driving range and routing to account for EV charging. Yet, another application factors in driver behavior, road statics, and vehicle information to make charging suggestions along a route to a destination. In another example, an EV manufacturer exposes vehicle metric data to an application so that the application can provide optimal routing and charging based on a destination input. The cited examples all require a destination to be specified by a user of the EV.

Moreover, none of the cited examples account for battery charging time as described herein. Specifically, EV charging station maps lack vehicle information that can be used to predict the amount of time it will take to charge the vehicle at specified charging locations, and routing applications do not account for the battery condition when arriving at the charging station or display a predicted time to charge.

Implementations according to this disclosure provide EV drivers with more information to make an informed decision about when and where to charge their electric vehicle. The described system can dynamically display locations, routes, and estimated charging times without the user of the EV inputting a destination. Moreover, the system can account for a variety of battery preconditioning and/or battery charging time factors or parameters, each of which can vary the amount of charging time. The parameters can include, but are not limited to, battery temperature, ambient temperature, charger type, state of battery charge, OEM charging schedules and/or rules, EV charging capacity, and charging station charging capacity. Each of these parameter can impact the charging time and/or charging speed. For example, batteries that are in a depleted state of battery charge can charge faster versus other battery charge states. In another example, battery temperature is needed because batteries that are too cold or too hot slow down charging. In yet another example, manufacturer information is needed because an OEM can regulate the rate of charge to maintain the health of the battery. The system can provide access to more integrated vehicle data and vehicle specific modeling that would affect battery usage and charging speed. In a further example, access to battery and charging station capacity is provided as charging is determined by which ever capacity is lower.

Implementations according to this disclosure provide optimized route and charging information based on battery state prediction when a route is not specified in advance. That is, the optimized route and charging information can be provided independent of a destination input. In implementations, the system can determine charging locations within a defined or configurable radius and/or distance from a location of the electric vehicle. The system can determine a route to one or more charging stations based on defined or configurable preference parameters. The system can use the route information, vehicle data and contextual information (e.g., traffic and weather) to make a prediction of the battery temperature and state of charge (collectively “battery state prediction” or “predicted battery precondition”) if traveled to each charging station. The system can use the battery state prediction and the type of charging station to determine an estimate of the time it will take to fully charge the battery. The system can display a map with the charging locations, one or more routes, and estimated charge times. In implementations, the map details can be updated based on electric vehicle movement. For example, charging locations can be added and/or removed based on electric vehicle route and trajectory.

As used herein, the term “model” may include, among other things, at least one of a classic planning model, an artificial intelligence (AI) model, or a machine-learning (ML) model that uses supervised learning, unsupervised learning, reinforcement learning, or the like. A model may be based on data that was generated in the past and may be used to predict future data. For example, a long-term shared world model of a roadway portion may store data about average velocities and congestion (e.g., number of vehicles per unit distance) of the roadway portion in the past (e.g., at multiple times in the past three years) and be used to predict the average velocities and the congestion of the roadway portion in the future (e.g., next Monday morning at 9 am). The prediction may be made, for example, using AI or ML techniques or other mathematical modeling techniques. Prediction and estimation models can use different physics models, machine learning and/or artificial intelligence algorithms including regression models, neural networks, statistic shortest path, Markov models, and/or combinations thereof.

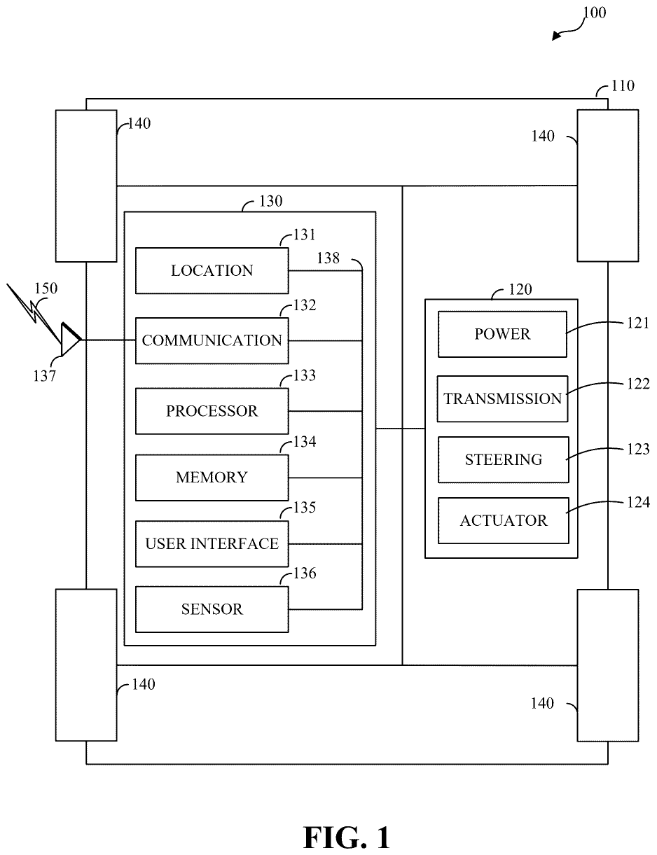

To describe some implementations in greater detail, reference is first made to examples of hardware and software structures used in providing optimized route and charging information based on battery state prediction when a route is not specified in advance, as described herein. FIG. 1 is a diagram of an example of a vehicle in which the aspects, features, and elements disclosed herein may be implemented. In the embodiment shown, a vehicle 100, which is an EV, includes various vehicle systems. The vehicle systems include a chassis 110, a powertrain 120, a controller 130, and wheels 140. Additional or different combinations of vehicle systems may be used. Although the vehicle 100 is shown as including four wheels 140 for simplicity, any other propulsion device or devices, such as a propeller or tread, may be used. In FIG. 1, the lines interconnecting elements, such as the powertrain 120, the controller 130, and the wheels 140, indicate that information, such as data or control signals, power, such as electrical power or torque, or both information and power, may be communicated between the respective elements. For example, the controller 130 may receive power from the powertrain 120 and may communicate with the powertrain 120, the wheels 140, or both, to control the vehicle 100, which may include accelerating, decelerating, steering, or otherwise controlling the vehicle 100.

The powertrain 120 shown by example in FIG. 1 includes a power source 121, a transmission 122, a steering unit 123, and an actuator 124. Any other element or combination of elements of a powertrain, such as a suspension, a drive shaft, axles, or an exhaust system may also be included. Although shown separately, the wheels 140 may be included in the powertrain 120.

The power source 121 includes an engine, a battery, or a combination thereof. The power source 121 may be any device or combination of devices operative to provide energy, such as electrical energy, thermal energy, or kinetic energy. In an example, the power source 121 includes an engine, such as an internal combustion engine, an electric motor, or a combination of an internal combustion engine and an electric motor, and is operative to provide kinetic energy as a motive force to one or more of the wheels 140. Alternatively or additionally, the power source 121 includes a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy. Thus, in an example, the power source 121 includes a battery and electric motor that supplies kinetic energy as a motive force to one or more wheels. In purely electric configurations, power management is achieved through a motor controller that adjusts the electrical current supplied to the motor, rather than by controlling air or fuel intake, as in an internal combustion engine.

The transmission 122 receives energy, such as kinetic energy, from the power source 121, transmits the energy to the wheels 140 to provide a motive force. The transmission 122 may be controlled by the controller 130, the actuator 124, or both. The steering unit 123 may be controlled by the controller 130, the actuator 124, or both and control the wheels 140 to steer the vehicle. The actuator 124 may receive signals from the controller 130 and actuate or control the power source 121, the transmission 122, the steering unit 123, or any combination thereof to operate the vehicle 100.

In the illustrated embodiment, the controller 130 includes a location unit 131, a communication unit 132, a processor 133, a memory 134, a user interface 135, a sensor 136, and a communication interface 137. Fewer of these elements may exist as part of the controller 130. Although shown as a single unit, any one or more elements of the controller 130 may be integrated into any number of separate physical units. For example, the user interface 135 and the processor 133 may be integrated in a first physical unit and the memory 134 may be integrated in a second physical unit. Although not shown in FIG. 1, the controller 130 may include a power source, such as a battery. Although not shown in FIG. 1, the controller 130 may include an engine control unit (ECU) (e.g., engine control module) and a Proportion-Integral-Derivate (PID) controller. Although shown as separate elements, the location unit 131, the communication unit 132, the processor 133, the memory 134, the user interface 135, the sensor 136, the communication interface 137, or any combination thereof may be integrated in one or more electronic units, circuits, or chips.

The processor 133 may include any device or combination of devices capable of manipulating or processing a signal or other information now-existing or hereafter developed, including optical processors, quantum processors, molecular processors, or a combination thereof. For example, the processor 133 may include one or more special purpose processors, one or more digital signal processors, one or more microprocessors, one or more controllers, one or more microcontrollers, one or more integrated circuits, one or more Application Specific Integrated Circuits, one or more Field Programmable Gate Array, one or more programmable logic arrays, one or more programmable logic controllers, one or more state machines, or any combination thereof. The processor 133 is operatively coupled with one or more of the location unit 131, the memory 134, the communication interface 137, the communication unit 132, the user interface 135, the sensor 136, and the powertrain 120. For example, the processor may be operatively coupled with the memory 134 via a communication bus 138.

The memory 134 includes any tangible non-transitory computer-usable or computer-readable medium, capable of, for example, containing, storing, communicating, or transporting machine readable instructions, or any information associated therewith, for use by or in connection with any processor, such as the processor 133. The memory 134 may be, for example, one or more solid state drives, one or more memory cards, one or more removable media, one or more read-only memories, one or more random access memories, one or more disks, including a hard disk, a floppy disk, an optical disk, a magnetic or optical card, or any type of non-transitory media suitable for storing electronic information, or any combination thereof. For example, a memory may be one or more read only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

The communication interface 137 may be a wireless antenna, as shown, a wired communication port, an optical communication port, or any other wired or wireless unit capable of interfacing with a wired or wireless electronic communication medium 150. Although FIG. 1 shows the communication interface 137 communicating via a single communication link, a communication interface may be configured to communicate via multiple communication links. Although FIG. 1 shows a single communication interface 137, a vehicle may include any number of communication interfaces.

The communication unit 132 is configured to transmit or receive signals via a wired or wireless electronic communication medium 150, such as via the communication interface 137. Although not explicitly shown in FIG. 1, the communication unit 132 may be configured to transmit, receive, or both via any wired or wireless communication medium, such as radio frequency (RF), ultraviolet (UV), visible light, fiber optic, wireline, or a combination thereof. Although FIG. 1 shows a single communication unit 132 and a single communication interface 137, any number of communication units and any number of communication interfaces may be used. In some embodiments, the communication unit 132 includes a dedicated short-range communications (DSRC) unit, an on-board unit (OBU), or a combination thereof.

The location unit 131 may determine geolocation information, such as longitude, latitude, elevation, direction of travel, or speed, of the vehicle 100. In an example, the location unit 131 includes a GPS unit, such as a Wide Area Augmentation System (WAAS) enabled National Marine-Electronics Association (NMEA) unit, a radio triangulation unit, or a combination thereof. The location unit 131 can be used to obtain information that represents, for example, a current heading of the vehicle 100, a current position of the vehicle 100 in two or three dimensions, a current angular orientation of the vehicle 100, or a combination thereof.

The user interface 135 includes any unit capable of interfacing with a person, such as a virtual or physical keypad, a touchpad, a display, a touch display, a heads-up display, a virtual display, an augmented reality display, a haptic display, a feature tracking device, such as an eye-tracking device, a speaker, a microphone, a video camera, a sensor, a printer, or any combination thereof. The user interface 135 may be operatively coupled with the processor 133, as shown, or with any other element of the controller 130. Although shown as a single unit, the user interface 135 may include one or more physical units. For example, the user interface 135 may include both an audio interface for performing audio communication with a person and a touch display for performing visual and touch-based communication with the person. The user interface 135 may include multiple displays, such as multiple physically separate units, multiple defined portions within a single physical unit, or a combination thereof.

The sensors 136 are operable to provide information that may be used to control the vehicle. The sensors 136 may be an array of sensors. The sensors 136 may provide information regarding current operating characteristics of the vehicle 100, including vehicle operational information. The sensors 136 can include, for example, a speed sensor, acceleration sensors, a steering angle sensor, traction-related sensors, braking-related sensors, steering wheel position sensors, eye tracking sensors, seating position sensors, or any sensor, or combination of sensors, which are operable to report information regarding some aspect of the current dynamic situation of the vehicle 100.

The sensors 136 include one or more sensors 136 that are operable to obtain information regarding the physical environment surrounding the vehicle 100, such as operational environment information. For example, one or more sensors may detect road geometry, such as lane lines, and obstacles, such as fixed obstacles, vehicles, and pedestrians. The sensors 136 can be or include one or more video cameras, laser-sensing systems, infrared-sensing systems, acoustic-sensing systems, or any other suitable type of on-vehicle environmental sensing device, or combination of devices, now known or later developed. In some embodiments, the sensors 136 and the location unit 131 are combined.

Although not shown separately, the vehicle 100 may include a trajectory controller. For example, the controller 130 may include the trajectory controller. The trajectory controller may be operable to obtain information describing a current state of the vehicle 100 and a route planned for the vehicle 100, and, based on this information, to determine and optimize a trajectory for the vehicle 100. In some embodiments, the trajectory controller may output signals operable to control the vehicle 100 such that the vehicle 100 follows the trajectory that is determined by the trajectory controller. For example, the output of the trajectory controller can be an optimized trajectory that may be supplied to the powertrain 120, the wheels 140, or both. In some embodiments, the optimized trajectory can be control inputs such as a set of steering angles, with each steering angle corresponding to a point in time or a position. In some embodiments, the optimized trajectory can be one or more paths, lines, curves, or a combination thereof.

One or more of the wheels 140 may be a steered wheel that is pivoted to a steering angle under control of the steering unit 123, a propelled wheel that is torqued to propel the vehicle 100 under control of the transmission 122, or a steered and propelled wheel that may steer and propel the vehicle 100.

Although not shown in FIG. 1, a vehicle may include additional units or elements not shown in FIG. 1, such as an enclosure, a Bluetooth® module, a frequency modulated (FM) radio unit, a Near Field Communication (NFC) module, a liquid crystal display (LCD) display unit, an organic light-emitting diode (OLED) display unit, a speaker, or any combination thereof.

The vehicle 100 may be an autonomous vehicle that is controlled autonomously, without direct human intervention, to traverse a portion of a vehicle transportation network. Although not shown separately in FIG. 1, an autonomous vehicle may include an autonomous vehicle control unit that performs autonomous vehicle routing, navigation, and control. The autonomous vehicle control unit may be integrated with another unit of the vehicle. For example, the controller 130 may include the autonomous vehicle control unit.

When present, the autonomous vehicle control unit may control or operate the vehicle 100 to traverse a portion of the vehicle transportation network in accordance with current vehicle operation parameters. The autonomous vehicle control unit may control or operate the vehicle 100 to perform a defined operation or maneuver, such as parking the vehicle. The autonomous vehicle control unit may generate a route of travel from an origin, such as a current location of the vehicle 100, to a destination based on vehicle information, environment information, vehicle transportation network information representing the vehicle transportation network, or a combination thereof, and may control or operate the vehicle 100 to traverse the vehicle transportation network in accordance with the route. For example, the autonomous vehicle control unit may output the route of travel to the trajectory controller to operate the vehicle 100 to travel from the origin to the destination using the generated route.

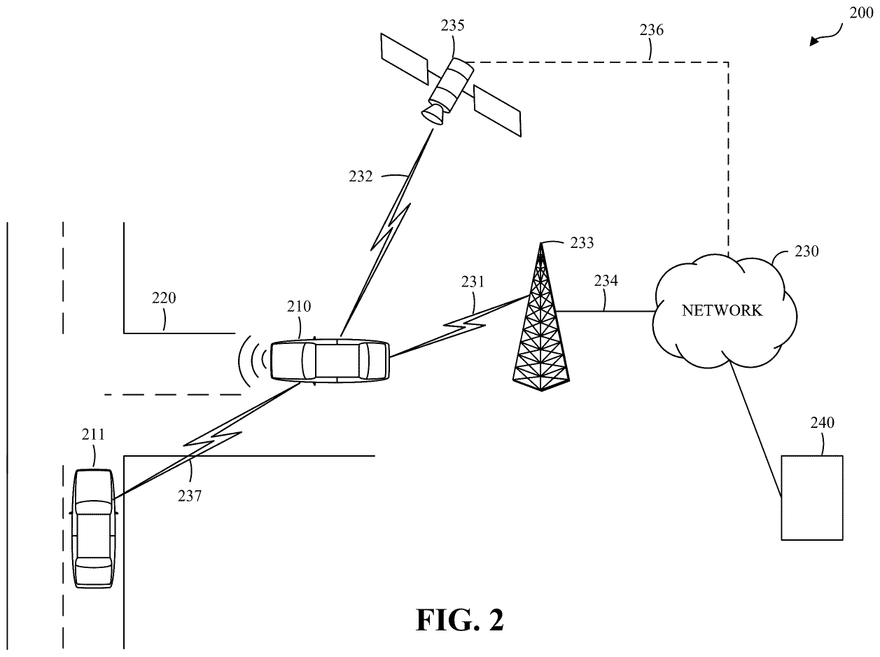

FIG. 2 is a diagram of an example of a portion of a vehicle transportation and communication system in which the aspects, features, and elements disclosed herein may be implemented. The vehicle transportation and communication system 200 may include one or more vehicles 210/211, such as the vehicle 100 shown in FIG. 1, which travels via one or more portions of the vehicle transportation network 220, and communicates via one or more communication networks 230. Although not explicitly shown in FIG. 2, a vehicle may traverse an off-road area.

The communication network 230 may be, for example, a multiple access system that provides for communication, such as voice communication, data communication, video communication, messaging communication, or a combination thereof, between the vehicle 210/211 and one or more communication devices 240. For example, a vehicle 210/211 may receive information, such as information representing the vehicle transportation network 220, from a communication device 240 via the communication network 230.

In some embodiments, a vehicle 210/211 may communicate via a wired communication link (not shown), a wireless communication link 231/232/237, or a combination of any number of wired or wireless communication links. As shown, a vehicle 210/211 communicates via a terrestrial wireless communication link 231, via a non-terrestrial wireless communication link 232, or via a combination thereof. The terrestrial wireless communication link 231 may include an Ethernet link, a serial link, a Bluetooth link, an infrared (IR) link, an ultraviolet (UV) link, or any link capable of providing for electronic communication.

A vehicle 210/211 may communicate with another vehicle 210/211. For example, a host, or subject, vehicle 210 may receive one or more automated inter-vehicle messages, such as a basic safety message (BSM), from a remote, or target, vehicle 211, via a direct communication link 237, or via the communication network 230. The remote vehicle 211 may broadcast the message to host vehicles within a defined broadcast range, such as 300 meters. In some embodiments, the vehicle 210 may receive a message via a third party, such as a signal repeater (not shown) or another remote vehicle (not shown). A vehicle 210/211 may define an interval, such as 100 milliseconds.

Automated inter-vehicle messages may include vehicle identification information, geospatial state information, such as longitude, latitude, or elevation information, geospatial location accuracy information, kinematic state information, such as vehicle acceleration information, yaw rate information, speed information, vehicle heading information, braking system status information, throttle information, steering wheel angle information, or vehicle routing information, or vehicle operating state information, such as vehicle size information, headlight state information, turn signal information, wiper status information, transmission information, or any other information, or combination of information, relevant to the transmitting vehicle state. For example, transmission state information may indicate whether the transmission of the transmitting vehicle is in a neutral state, a parked state, a forward state, or a reverse state.

The vehicle 210 may communicate with the communications network 230 via an access point 233. The access point 233, which may include a computing device, is configured to communicate with a vehicle 210, with a communication network 230, with one or more communication devices 240, or with a combination thereof via wired or wireless communication links 231/234. For example, the access point 233 may be a base station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit here, an access point may include any number of interconnected elements.

The vehicle 210 may communicate with the communications network 230 via a satellite 235, or other non-terrestrial communication device. The satellite 235, which may include a computing device, is configured to communicate with a vehicle 210, with a communication network 230, with one or more communication devices 240, or with a combination thereof via one or more communication links 232/236. Although shown as a single unit here, a satellite may include any number of interconnected elements.

A communication network 230 is any type of network configured to provide for voice, data, or any other type of electronic communication. For example, the communication network 230 may include a local area network (LAN), a wide area network (WAN), a virtual private network (VPN), a mobile or cellular telephone network, the Internet, or any other electronic communication system. The communication network 230 uses a communication protocol, such as the transmission control protocol (TCP), the user datagram protocol (UDP), the internet protocol (IP), the real-time transport protocol (RTP) the HyperText Transport Protocol (HTTP), or a combination thereof. Although shown as a single unit here, an electronic communication network may include any number of interconnected elements.

The vehicle 210 may identify a portion or condition of the vehicle transportation network 220. For example, the vehicle includes at least one on-vehicle sensor, like the sensor 136 shown in FIG. 1, which may be or include a speed sensor, a wheel speed sensor, a camera, a gyroscope, an optical sensor, a laser sensor, a radar sensor, a sonic sensor, or any other sensor or device or combination thereof capable of determining or identifying a portion or condition of the vehicle transportation network 220.

The vehicle 210 may traverse a portion or portions of the vehicle transportation network 220 using information communicated via the communication network 230, such as information representing the vehicle transportation network 220, information identified by the at least one on-vehicle sensors 209, or a combination thereof.

Although FIG. 2 shows a vehicle transportation network 220, one communication network 230, and one communication device 240, for simplicity, any number of networks or communication devices may be used. The vehicle transportation and communication system 200 may include devices, units, or elements not shown in FIG. 2. Although the vehicle 210 is shown as a single unit, a vehicle may include any number of interconnected elements.

Although the vehicle 210 is shown communicating with the communication device 240 via the communication network 230, the vehicle 210 may communicate with the communication device 240 via any number of direct or indirect communication links. For example, the vehicle 210 may communicate with the communication device 240 via a direct communication link, such as a Bluetooth communication link.

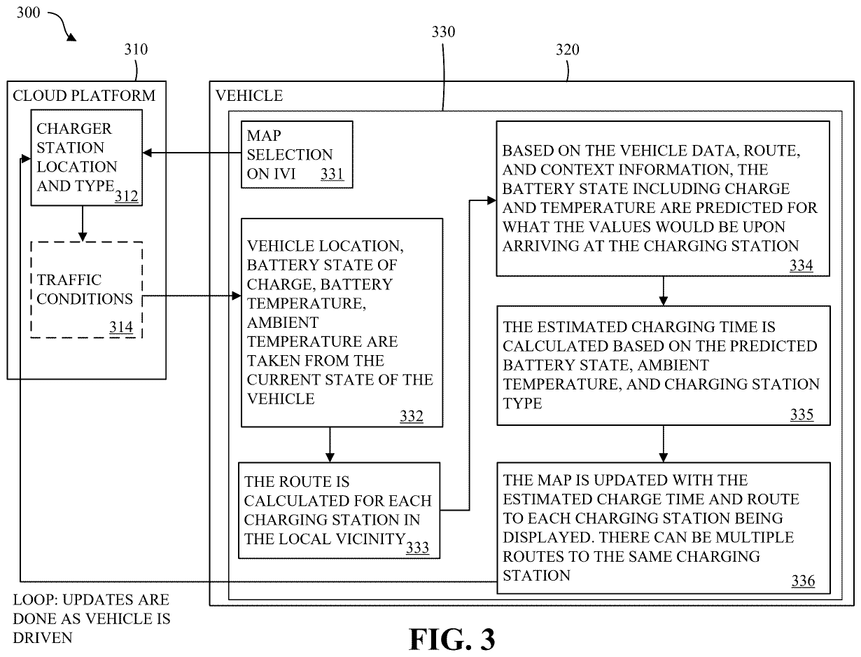

FIG. 3 illustrates a block diagram of a system 300 for displaying electric vehicle charge times based on battery state prediction when a route is not specified in advance. The system 300 includes a cloud platform and/or a cloud-based system 310 and a vehicle 320, which can be the vehicle 100 of FIG. 1. In implementations, communications between the cloud platform and/or a cloud-based system 310 and the vehicle 320 can be established via, but not limited to, the communication links and/or the communication network as described herein, HTTP, TCP, MQTT, Bluetooth, and/or other communication protocols. The vehicle 320 can include an electric vehicle charge time estimator and/or controller 330, which can be implemented using or as part of the processor 133 of FIG. 1 and in cooperation with the other components described in FIG. 1.

Operationally, at 331, a user selects, opens, or triggers a map to display on an in-vehicle infotainment (IVI) system, which can be the user interface 135 in cooperation with the processor 1330 and other components in the vehicle 100. In implementations, the system can use visual displays with tactile inputs, accept verbal commands using speech recognition and a large language model, and/or combinations thereof. The electric vehicle charge time estimator 330 can execute a route and charging optimization algorithm in response to the user selection of the map. There is no need for entry of a destination to execute the route and charging optimization algorithm. The electric vehicle charge time estimator 330 can obtain charger information, such as but not limited to, charger station location and charger type information from the cloud platform 310 (312). In implementations, the electric vehicle charge time estimator 330 can obtain traffic conditions from the cloud platform 310 (314). In implementations, the electric vehicle charge time estimator 330 can determine the traffic conditions (e.g., local traffic conditions) using sensors, such as the sensors 136 of FIG. 1. At 332, a current state of the vehicle 320 can be determined from vehicle data including, but not limited to, vehicle telemetry (e.g., speed, acceleration, braking, location), battery state (e.g., current state of charge, battery temperature), and environmental information (e.g., road grading, speed limit, weather, ambient temperature).

At 333, the electric vehicle charge time estimator 330 can determine a set of charger station locations within a defined and/or configurable distance of the vehicle location. In implementations, the set of charger station locations can be adjusted and/or pruned based on preferences. In implementations, the preferences can be based on, but not limited to, past charging behavior of the user, past charging behavior associated with the vehicle, previously visited charger locations, user identified preferences, and/or combinations thereof. A route and travel time can be determined for each charger station location. In implementations, multiple routes can be determined for each charger station location. In implementations, a route can be based on a current vehicle location and a charger station location. In implementations, a route can be based on a current vehicle location and trajectory of the vehicle. In implementations, a route can be based on a future vehicle location and a charger station location. In implementations, a route can be based on a future vehicle location and trajectory of the vehicle. In implementations, a route can be based on previous driving behavior. In implementations, a route can be based on preferred routes. In implementations, a route can be based on, but is not limited to, current vehicle location, future vehicle location, charger station location, trajectory of the vehicle, previous driving behavior, preferred routes, and/or combinations thereof.

As noted, a user inputted destination is not required for operation of the electric vehicle charge time estimator 330 and the route and charging optimization algorithm. In implementations, the electric vehicle charge time estimator 330 and the route and charging optimization algorithm can use current vehicle speed information, trajectory information, and local map information to determine a likely short-term path (e.g., a short-term path having an associated probability value) that can be used to select viable charger station locations (i.e., the one or more charger station locations) and optimize the route from the current location to the charger station location.

In implementations, the electric vehicle charge time estimator 330 and the route and charging optimization algorithm can, in addition to the trajectory information, use past behavior by the user and/or vehicle to form a probability of the path the vehicle is taking. In implementations, the system and techniques described in U.S. patent application Ser. No. 18/413,855, filed on Jan. 16, 2024, and titled “Navigation Map Learning for Intelligent Hybrid-Electric Vehicle Planning”, the contents of which are herein incorporated reference as if set forth herein, can be used to determine a predicted short-term route of the vehicle. In summary, the described method therein includes analyzing historical driving data of the vehicle to identify recurring driving scenarios and patterns specific to a driver of the vehicle, predicting future driving scenarios based on the historical driving data, generating an engine activation policy for the vehicle, where the engine activation policy optimizes battery charging and usage in response to the future driving scenarios, and using the engine activation policy to control activation of a gasoline engine in the vehicle, where a control decision is dynamically adjusted based on a comparison of real-time driving conditions with the future driving scenarios. Engine activation refers to how and/or when to turn on or turn off the engine to recharge the battery. In implementations, the electric vehicle charge time estimator 330 and the route and charging optimization algorithm can, in addition to the trajectory information, use a generalized path probability by looking at the behavior of similar vehicle owners when in the same location.

At 334, for each route, the electric vehicle charge time estimator 330 can use a battery precondition prediction model and an energy usage prediction model to determine values for a predicted battery state (or predicted energy state) at a charger station location. That is, the values are for when the vehicle arrives and/or is at the charger station location. The predicted battery state can include values for, but is not limited to, predicted battery charge state, predicted battery temperature, and/or predicted energy usage. In implementations, an estimated wait time could be determined to account for how long the user can expect to wait for a free charger. The predicted battery state can be adjusted based on the estimated wait time as a longer wait time would cool the battery, which in turn can lead to a longer charge time.

In implementations, the battery precondition prediction model and an energy usage prediction model can be deep learning models trained on vehicle data including, but not limited to, vehicle telemetry (e.g., speed, acceleration, braking), battery state (e.g., current state of charge, battery temperature), and environmental information (e.g., road grading, speed limit, weather, temperature). In implementations, the models can be fined tuned to the vehicle over time using confederated learning, for example, to update the models based on new data collected for the user and/or vehicle.

At 335, an estimated charging time can be determined based on, but not limited to, the predicted battery state, the ambient temperature, and the charger station information (e.g., charger station type). In implementations, a user can input a desired charging level. For example, the user may want to charge to 50%. The estimated charging time can then be adjusted for the desired charging level. In implementations, the cost for the estimated charging time can also be determined.

At 336, the map can be populated with the charger station locations, the one or more routes to the charger station locations, the estimated charging time, and the estimated cost (when available) (collectively “predicted charger station data”). A user can select a charger station location using a user interface, such as the user interface 135 of FIG. 1, to receive turn-by-turn navigation. In implementations, the user can input an amount of time that the user has available to charge. In these instances, the predicted charger station data can also include an expected battery and/or charge level based on the available time to charge.

The route and charging optimization algorithm can update the predicted charger station data on the map as the vehicle 320 travels or due to movement of the vehicle 320. That is, the predicted charger station data on the map can be updated based on the speed, trajectory, and predicted short-term route (e.g., movement) of the vehicle 320. In implementations, updates to the map can remove predicted charger station data for charger station locations that fall outside of the defined or configurable distance. In implementations, updates to the map can add predicted charger station data for charger station locations that are now within the defined or configurable distance. In implementations, updates to the map can update predicted charger station data for charger station locations that remain within the defined or configurable distance.

In implementations, the electric vehicle charge time estimator 330 and the route and charging optimization algorithm can send statistical data to the cloud platform and/or a cloud-based system 310. The statistical data can include, but is not limited to, route probabilities, actual routes taken, vehicle data to determine and/or classify behavior, battery information, actual charging times versus predicted charging times, and/or charger station information. The models described herein can be updated and/or personalized based on the statistical data. In implementations, the models can be tailored to individual vehicles to account for battery degradation over time. The models on the vehicles can be updated with the new models.

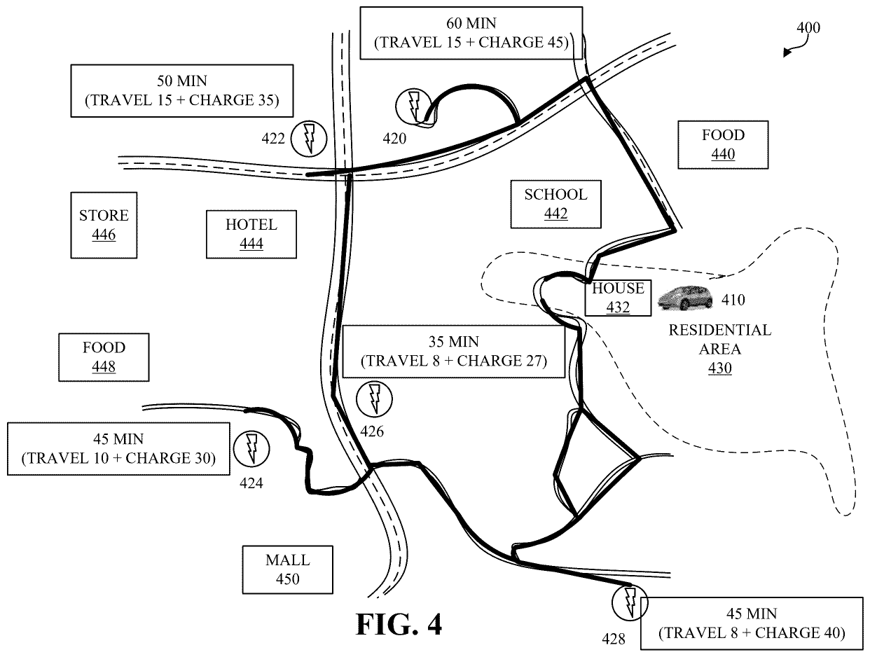

FIG. 4 illustrates a display with a map 400 for dynamic display of charger station locations, routes, and estimated charging times based on predicted battery state without the user of the vehicle inputting a destination. In implementations, the time to travel to the charger station location is also displayed. In implementations, routes can vary based on the predicted battery state, battery temperature, and ambient temperature. On cold days, longer routes or routes with higher speeds may be preferred because it increases the battery temperature before charging.

The map 400 shows a vehicle 410 parked at house 432 in a residential area 430. The map 400 shows multiple charger station locations with predicted and/or estimate charging times and routes (dark lines) including charger stations 420, 422, 424, 426, and 428. The map 400 also shows a variety of services and/or premises including food 440, school 442, hotel 444, store 446, food 448, and mall 450. As described herein, the map 400 can be updated as the vehicle 410 travels and/or based on the speed, trajectory, and predicted short-term route of the vehicle 410.

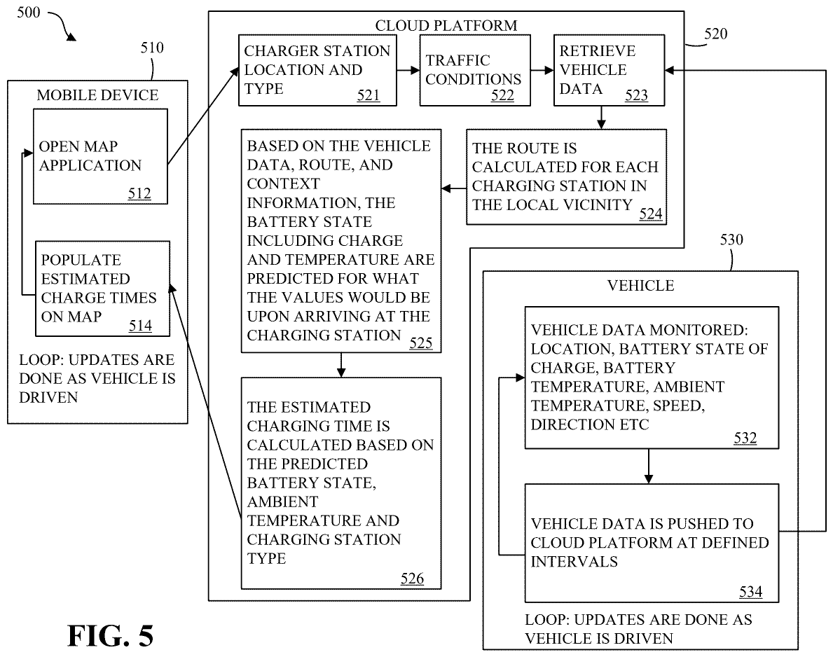

FIG. 5 illustrates a block diagram of a system 500 for dynamic display of charger station locations, routes, and estimated charging times based on predicted battery state without the user of the vehicle inputting a destination. The system 500 includes a mobile device 510, a cloud platform and/or a cloud-based system 520, and a vehicle 530, which can be the vehicle 100 of FIG. 1. In implementations, the mobile device 510 can be in communication with the cloud platform and/or a cloud-based system 520, the vehicle 530, and/or combinations thereof. In implementations, the mobile device 510 can be in communication with the vehicle 530, which in turn is in communication with the cloud platform and/or a cloud-based system 520. In implementations, the communications can be established via, but not limited to, the communication links and/or the communication network as described herein, HTTP, TCP, MQTT, Bluetooth, and/or other communication protocols. The system 500 can implement an electric vehicle charge time estimator and route and charging optimization algorithm as described in FIG. 3 in the cloud platform and/or a cloud-based system 520 in cooperation with the mobile device 510 and the vehicle 530. The electric vehicle charge time estimator and route and charging optimization algorithm can function as described in FIG. 3 subject to the description below.

Operationally, at 512, a user of the mobile device 510 opens a map application available and/or running on the mobile device 510. The opening of the map application can trigger the electric vehicle charge time estimator and route and charging optimization algorithm. At 521 and 522, the cloud platform and/or a cloud-based system 520 can obtain charger information, such as but not limited to, charger station location and charger type information, and traffic conditions, respectively. At 523, the cloud platform and/or a cloud-based system 520 can obtain a current state of the vehicle 530 based on vehicle data including, but not limited to, vehicle telemetry (e.g., speed, acceleration, braking, location), battery state (e.g., current state of charge, battery temperature), and environmental information (e.g., road grading, speed limit, weather, ambient temperature). In implementations, at 532, the vehicle 530 can continuously or periodically monitor the vehicle data and at 534, push the vehicle data to the cloud platform and/or a cloud-based system 520.

At 524, 525, and 526, the electric vehicle charge time estimator and route and charging optimization algorithm can determine the predicted charger station data including one or more routes to charger station locations, estimated charging times, and estimated costs (when available) as described with respect to the system 300 of FIG. 3. At 526, the cloud platform and/or a cloud-based system 520 can send and/or transmit the predicted charger station data to the mobile device 510.

At 514, the mobile device 510 and/or the map application can populate a map with the predicted charger station data. The user can select a charger station location using a user interface on the mobile device 510 to receive turn-by-turn navigation. As before, the map can be updated with updated predicted charger station data as the vehicle 530 travels and/or based on the speed, trajectory, and predicted short-term route of the vehicle 530.

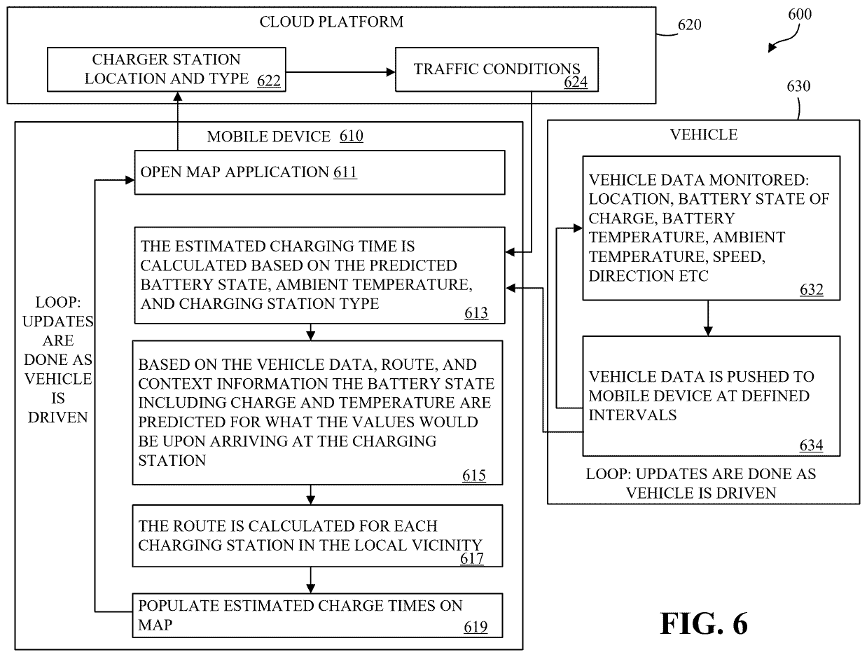

FIG. 6 illustrates a block diagram of a system 600 for dynamic display of charger station locations, routes, and estimated charging times based on predicted battery state without the user of the vehicle inputting a destination. The system 600 includes a mobile device 610, a cloud platform and/or a cloud-based system 620, and a vehicle 630, which can be the vehicle 100 of FIG. 1. In implementations, the mobile device 610 can be in communication with the cloud platform and/or a cloud-based system 620, the vehicle 630, and/or combinations thereof. In implementations, the mobile device 610 can be in communication with the vehicle 630, which in turn is in communication with the cloud platform and/or a cloud-based system 620. In implementations, the communications can be established via, but not limited to, the communication links and/or the communication network as described herein, HTTP, TCP, MQTT, Bluetooth, and/or other communication protocols. The system 600 can implement an electric vehicle charge time estimator and route and charging optimization algorithm as described in FIG. 3 and FIG. 5 in the mobile device 610 in cooperation with the cloud platform and/or a cloud-based system 620 and the vehicle 630. The electric vehicle charge time estimator and route and charging optimization algorithm can function as described in FIG. 3 and FIG. 5 subject to the description below.

Operationally, at 611, a user of the mobile device 610 opens a map application available and/or running on the mobile device 610. The opening of the map application can trigger the electric vehicle charge time estimator and route and charging optimization algorithm. At 622 and 624, the mobile device 610 can obtain charger information, such as but not limited to, charger station location and charger type information, and traffic conditions, respectively, from the cloud platform and/or a cloud-based system 620.

At 613, the mobile device 610 can obtain a current state of the vehicle 630 based on vehicle data including, but not limited to, vehicle telemetry (e.g., speed, acceleration, braking, location), battery state (e.g., current state of charge, battery temperature), and environmental information (e.g., road grading, speed limit, weather, ambient temperature). In implementations, at 632, the vehicle 630 can continuously or periodically monitor the vehicle data and at 634, push the vehicle data to the mobile device 610.

At 613, 615, 617, and 619, the electric vehicle charge time estimator and route and charging optimization algorithm can determine the predicted charger station data including one or more routes to charger station locations, estimated charging times, and estimated costs (when available), and populate the map with the predicted charger station data as described with respect to the system 300 of FIG. 3 and/or the system 500 of FIG. 5, as appropriate. As before, the user of mobile device 610 can select a charger station location using a user interface on the mobile device 610 to receive turn-by-turn navigation. The map can be updated with updated predicted charger station data as the vehicle 630 travels and/or based on the speed, trajectory, and predicted short-term route of the vehicle 630.

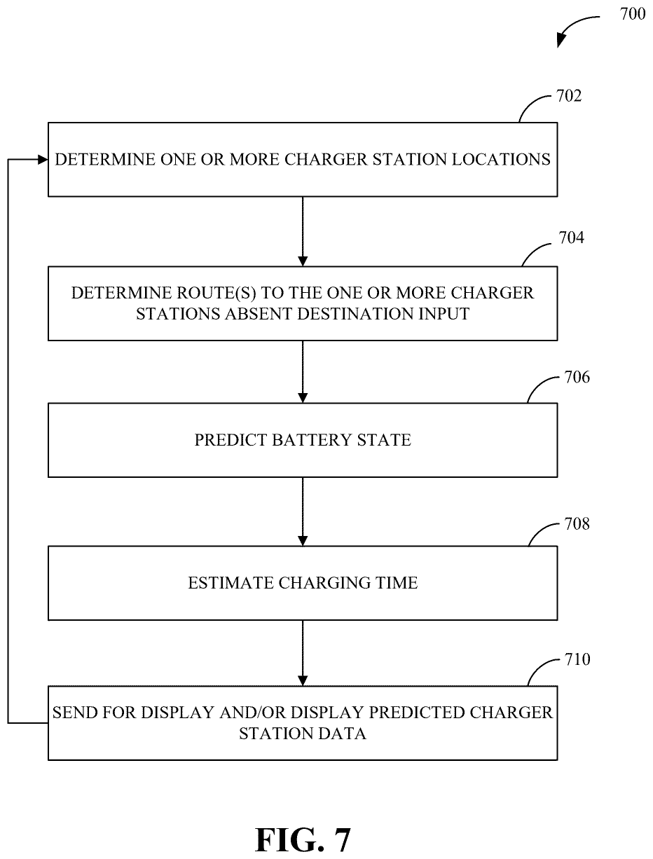

To further describe some implementations in greater detail, reference is next made to examples of techniques which may be performed for, inter alia, dynamic display of charger station locations, routes, and estimated charging times based on predicted battery state without the user of the vehicle inputting a destination. FIG. 7 is a flowchart of an examples of a technique 700 that can be used for dynamic display of charger station locations, routes, and estimated charging times based on predicted battery state without the user of the vehicle inputting a destination. The technique 700 can be executed using devices, such as the EVs (such as the vehicle 100 of FIG. 1), systems, hardware, and software described with respect to FIGS. 1-6. The technique 700 can be performed, for example, by executing respective machine-readable programs or other computer-executable instructions, such as routines, instructions, programs, or other code. The steps, or operations, of the technique 700 or another technique, method, process, or algorithm described in connection with the implementations disclosed herein can be implemented directly in hardware, firmware, software executed by hardware, circuitry, or a combination thereof. The technique 700 can be executed by the electric vehicle charge time estimator 330 of FIG. 3 of a vehicle. The technique 700 executes a route and charging optimization algorithm based on predicted battery state without the user of the vehicle inputting a destination.

At 702, the technique 700 determines and/or identifies one or more charger station locations based on a vehicle location, a defined or configurable distance, preferred charger station locations, previously used and/or visited charger station locations, and/or combinations thereof. The set of charger station locations can be obtained from a cloud-based system, from a database stored on the vehicle (which is updated periodically and/or on-demand), from a database stored on a mobile device (which is updated periodically and/or on-demand), and/or combinations thereof. The technique 700 also obtains traffic conditions. The traffic conditions can be obtained from the cloud-based system, from the vehicle (e.g., by using vehicle sensors), from a mobile device (e.g., by using applications and sensors), and/or combinations thereof. The traffic conditions can be used to predict a temperature of the battery upon reaching a charger station location, for example. That is, the traffic conditions can be used to determine the predicted battery state as described herein.

At 704, the technique 700 determines one or more routes to the determined or identified charger station locations. The one or more routes are determined absent a user inputted destination using the techniques described herein. In implementations, each identified charger station location can have multiple routes.

At 706, the technique 700 determines a predicted battery state for each of the one or more routes using the techniques described herein. The predicted battery state can include values for, but is not limited to, predicted battery charge state, predicted battery temperature, and/or predicted energy usage. In implementations, vehicle data can be obtained from the vehicle.

At 708, the technique 700 determines an estimated charging time for each of the one or more routes using the techniques described herein. The estimated charging time can be based on the predicted battery state, the ambient temperature, and charger station information. In implementations, the estimated charging time can include an estimated travel time portion (i.e., travel time to charger station location) and an estimated charging time portion (i.e., that portion of the time determined for charging versus the travel time).

At 710, the technique 700 sends for display and/or displays predicted charger station data for display on a user interface. The predicted charger station data can include the one or more routes to the charger station locations, the estimated charging time, and the estimated cost (when available). The technique 700 can update the predicted charger station data as the vehicle travels.

A method for dynamic display of estimated electric vehicle charge times based on predicted battery preconditioning and absent destination route input is described. In implementations, the method is implemented by an electric vehicle (EV) includes identifying one or more charger station locations based on a location of the EV vehicle and a defined distance, determining one or more routes for the one or more charger station locations absent a destination input, determining, for each of the one or more routes, values for a predicted battery state based on vehicle data, determining, for each of the one or more routes, an estimated charge time based on the predicted battery state, an ambient temperature, and charger station information, and providing the one or more charger station locations, the one or more routes, and associated estimated charging times for display to a user.

In implementations, identification of the one or more charger station locations further uses at least one or preferred charger station locations and previously used charger station locations. In implementations, the method further includes obtaining traffic conditions, wherein the traffic conditions are used in determining the values for the predicted battery state. In implementations, the values for the predicted battery state include a value for a predicted battery charge state and a value for a predicted battery temperature. In implementations, the values for the predicted battery state are determined by a trained battery precondition prediction model and a trained energy usage prediction model. In implementations, the estimated charge time includes an estimated travel time portion and an estimated charging time portion. In implementations, the estimated charge time is further based on a user desired charging level. In implementations, further includes determining, for each estimated charge time, an estimated cost, wherein the estimated cost is provided for display to the user. In implementations, further includes determining, for each of the one or more routes, an expected battery charge level based on a user available time to charge, wherein the expected battery charge level is provided for display to the user. In implementations, opening a map on a device triggers the identifying of the one or more charger station locations. In implementations, the device is one of the EV or a mobile device. In implementations, further includes obtaining the vehicle data from the EV, wherein the vehicle data includes vehicle telemetry data, battery state, and environmental information. In implementations, the one or more routes can be based on one or more of a current vehicle location, a future vehicle location, a charger station location, a trajectory of the EV, a previous driving behavior, and preferred routes. In implementations, the determining one or more routes further includes using current EV speed information, trajectory information, and local map information to determine a short-term path having an associated probability value to select the one or more charger station locations and optimize the one or more routes from the vehicle location to the one or more charger station locations. In implementations, the short-term path having the associated probability value is based on past behavior by a user or the EV. In implementations, the short-term path having the associated probability value is based on a generalized path probability by looking at behavior of similar EV owners when in a same location. In implementations, the method further includes updating the one or more charger station locations, the one or more routes, and the associated estimated charging times based on movement of the EV.

An electric vehicle (EV) for dynamic display of estimated electric vehicle charge times based on predicted battery preconditioning and absent destination route input is described. In implementations, the EV includes a processor. The processor is configured to identify one or more charger station locations based on a location of the EV vehicle and a defined distance, determine one or more routes for the one or more charger station locations absent a destination input, determine, for each of the one or more routes, values for a predicted battery state based on vehicle data, determine, for each of the one or more routes, an estimated charge time based on the predicted battery state, an ambient temperature, and charger station information, and provide the one or more charger station locations, the one or more routes, and associated estimated charging times for display to a user.

In implementations, the processor is further configured to obtain traffic conditions, wherein the traffic conditions are used in determining the values for the predicted battery state, and use a trained battery precondition prediction model and a trained energy usage prediction model to determine the values for the predicted battery state.

A non-transitory computer readable medium storing instructions operable to cause a processor to perform operations with respect to an electric vehicle (EV), the operations for dynamic displaying estimated electric vehicle charge times based on predicted battery preconditioning and absent destination route input is described. The operations include identifying one or more charger station locations based on a location of the EV vehicle and a defined distance, determining one or more routes for the one or more charger station locations absent a destination input, determining, for each of the one or more routes, values for a predicted battery state based on vehicle data, determining, for each of the one or more routes, an estimated charge time based on the predicted battery state, an ambient temperature, and charger station information, and providing the one or more charger station locations, the one or more routes, and associated estimated charging times for display to a user.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the terminology “example,” “embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify,” or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or” unless specified otherwise, or clear from context. In addition, the articles “a” and “an” as used in this application and the appended claims should generally be construed to mean “one or more” unless specified otherwise or clear from context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

The above-described aspects, examples, and implementations have been described in order to allow easy understanding of the disclosure are not limiting. On the contrary, the disclosure covers various modifications and equivalent arrangements included within the scope of the appended claims, which scope is to be accorded the broadest interpretation so as to encompass all such modifications and equivalent structure as is permitted under the law.

What is claimed is:

1. A method implemented by an electric vehicle (EV), comprising:
identifying one or more charger station locations based on a location of the EV vehicle and a defined distance;
determining one or more routes for the one or more charger station locations absent a destination input;
determining, for each of the one or more routes, values for a predicted battery state based on vehicle data;
determining, for each of the one or more routes, an estimated charge time based on the predicted battery state, an ambient temperature, and charger station information; and
providing the one or more charger station locations, the one or more routes, and associated estimated charging times for display to a user.

2. The method of claim 1, wherein identification of the one or more charger station locations further uses at least one or preferred charger station locations and previously used charger station locations.

3. The method of claim 1, further comprising:
obtaining traffic conditions, wherein the traffic conditions are used in determining the values for the predicted battery state.

4. The method of claim 1, wherein the values for the predicted battery state include a value for a predicted battery charge state and a value for a predicted battery temperature.

5. The method of claim 1, wherein the values for the predicted battery state are determined by a trained battery precondition prediction model and a trained energy usage prediction model.

6. The method of claim 1, wherein the estimated charge time includes an estimated travel time portion and an estimated charging time portion.

7. The method of claim 1, wherein the estimated charge time is further based on a user desired charging level.

8. The method of claim 1, the method further comprising:
determining, for each estimated charge time, an estimated cost, wherein the estimated cost is provided for display to the user.

9. The method of claim 1, the method further comprising:
determining, for each of the one or more routes, an expected battery charge level based on a user available time to charge, wherein the expected battery charge level is provided for display to the user.

10. The method of claim 1, wherein opening a map on a device triggers the identifying of the one or more charger station locations.

11. The method of claim 10, wherein the device is one of the EV or a mobile device.

12. The method of claim 1, further comprising:
obtaining the vehicle data from the EV, wherein the vehicle data includes vehicle telemetry data, battery state, and environmental information.

13. The method of claim 1, wherein the one or more routes can be based on one or more of a current vehicle location, a future vehicle location, a charger station location, a trajectory of the EV, a previous driving behavior, and preferred routes.

14. The method of claim 1, wherein the determining one or more routes further comprises:
using current EV speed information, trajectory information, and local map information to determine a short-term path having an associated probability value to select the one or more charger station locations and optimize the one or more routes from the vehicle location to the one or more charger station locations.

15. The method of claim 14, wherein the short-term path having the associated probability value is based on past behavior by a user or the EV.

16. The method of claim 14, wherein the short-term path having the associated probability value is based on a generalized path probability by looking at behavior of similar EV owners when in a same location.

17. The method of claim 1, further comprising:
updating the one or more charger station locations, the one or more routes, and the associated estimated charging times based on movement of the EV.

18. An electric vehicle (EV), comprising:
a processor, configured to:
identify one or more charger station locations based on a location of the EV vehicle and a defined distance;
determine one or more routes for the one or more charger station locations absent a destination input;
determine, for each of the one or more routes, values for a predicted battery state based on vehicle data;
determine, for each of the one or more routes, an estimated charge time based on the predicted battery state, an ambient temperature, and charger station information; and
provide the one or more charger station locations, the one or more routes, and associated estimated charging times for display to a user.

19. The electric vehicle of claim 18, wherein the processor is further configured to:
obtain traffic conditions, wherein the traffic conditions are used in determining the values for the predicted battery state; and
use a trained battery precondition prediction model and a trained energy usage prediction model to determine the values for the predicted battery state.

20. A non-transitory computer readable medium storing instructions operable to cause a processor to perform operations with respect to an electric vehicle (EV), the operations comprising:
identifying one or more charger station locations based on a location of the EV vehicle and a defined distance;
determining one or more routes for the one or more charger station locations absent a destination input;
determining, for each of the one or more routes, values for a predicted battery state based on vehicle data;
determining, for each of the one or more routes, an estimated charge time based on the predicted battery state, an ambient temperature, and charger station information; and
providing the one or more charger station locations, the one or more routes, and associated estimated charging times for display to a user.
